(19) United States
(12) Patent Application Publication
(10) Pub. No.: US 2012/0261492 A1
(43) Pub. Date: Oct. 18, 2012

(54) MULTI-COMPONENT PRESSURE SPRAYGUN SYSTEM

(76) Inventors: Jeff Lichthardt, (US); Clifford Hedquist, Naperville, IL (US)

(21) Appl. No.: 13/088,377

(22) Filed: Apr. 17, 2011

(51) Int. Cl. B05B 7/02

(52) U.S. Cl. 239/337

(57) ABSTRACT

A multi-component system to feed two fluid materials, water and a cleaning agent, from a fluid tank to a spraygun is described. The fluid tank comprises a separation wall within the tank, to separate the two fluids from each other. A rechargeable battery-powered pump creates the pressure and the fluid components are drawn through their respective tube into a central tube, where the components combine before entering the spraygun.

### CROSS-REFERENCES TO RELATED APPLICATIONS

(Not Applicable)

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

### FIELD OF THE INVENTION

This invention relates generally to pressure washing sprayguns, and specifically to a portable professional-grade pressure spraygun for industrial and home use. The system has a spray gun with detachable barrels having various spray configurations, a pump powered by a rechargeable battery system, and a two-component solution tank.

The invention avoids a disadvantage seen in the prior art where, in larger systems for example, when a two-component fluid spray gun systems utilizes two separate tanks which increases the space and costs.

Another disadvantage with prior art sprayguns is in smaller home-use portable unites. These sprayguns are principally manufactured from moulding parts of the body and handle in a light weight synthetic resinous material. Such models are ineffective use for residential household purposes, however. Those prior art spray washers do not effectively clean outside deck surfaces, air conditioner grills, and automobiles, due to a low pressure per square inch (psi) output.

An aim of the present invention is to overcome these disadvantages by providing a single portable rechargeable pressure washing spraygun system to feed a two component fluid cleaning solution to a spray gun, specifically, a solvent and water. Another aim of the present invention is to overcome these disadvantages by providing a single portable rechargeable pressure washing spraygun system that will include detachable barrels, including a non-rigid hose barrel for spraying and seal-fitting to an air conditioner drain line in order to pressure-cleaning inside utility machines, such as inner walls of furnaces and air conditioner drain lines.

A further aim of the present invention is to overcome these disadvantages by providing a portable rechargeable pressure washing spraygun system that will include enough portable water and cleaning solution volume to eliminate a need to hook into residential water systems through garden hoses, but still be able to do so.

### BRIEF SUMMARY OF THE INVENTION

In the applicant's present invention there is described and claimed a spraygun with detachable spraygun barrel designs, each having a fluid orifice for discharging a cleaning solution solvent or water fluid jet. Cleaning detergent and water each feed from a multi-component portable tank into a main spraygun hose, where they control mix by stopcock valve before entering the spraygun.

### BRIEF DESCRIPTION OF THE SEVERAL VIEWS OF THE DRAWINGS

Applicant believes that drawings may not presently be needed, but applicant is prepared to comply with any request by the Office to submit drawings.

### DETAILED DESCRIPTION OF THE INVENTION

In operation of the pressure system, water flows from the pressure feed tank via the adjustable water regulator. The water and solution are both pumped into their respective flow tube into a main spray gun tube. The amount of solvent from the second tank is regulated by the stopcock valve.

The combined system comprises a main first major tank with a lid. The first major tank typically contains water and is a 6-gallon jug. The tank has an aperture to hold at least one second solvent tank.

The second minor fluid tank is located in the first tank for holding a second fluid solvent component. The solvent tank is a removable unit that is inserted into the first tank. The solvent tank is sealable with its own lid and is removable from the first tank.

The lid on the second minor tank has is wider than the aperture into which the insertable tank is placed. The lid of the second tank has a greater diameter than the aperture in the wall of the first tank. In this way, the second tank does not slip all the way into the first tank, although the second tank sits below the water line. The solvent tank can simply be removed.

The second solvent tank holds a cleaning liquid, such as a detergent or chemical solvent. The wall of the second tank serves as a partition wall between the fluid components. The solvent tank can be refilled with chemical solvent and inserted into the main water jug, underneath the water line in the first tank.

The lid has an airvent. A swivel ball joint is fixed to each lid on the jug and on the solvent tank. Hoses are fixed to each swivel ball joint. The hoses feed into a variable mixing stopcock.

The invention has a power unit. The power unit has a rechargeable lead acid battery and a 11.5 to 2 volt DC current diaphragm pump. This is a standard pump that alone has a maximum output of 350 psi, and operating range of 150-350 psi. The power unit has a safety circuit shuts off the unit automatically to preserve the battery. The power unit provides approximately 2 hours of constant pressure.

The invention has male and female standard connections throughout system for hose connections. The power unit has a holster and an organizing tray for holding the various barrels for the spray gun. An activation switch is positioned on the outside shell of the power unit for a user to power-on the invention.

The invention has a spraygun. The spraygun has at least two detachable barrels. A first extended barrel is a longitudinally extended spraygun barrel having a a spraycap fixed to distal end of the longitudinal barrel through which the liquid cleaning solution flows. The distal end hole is formed perpendicular to the flow of the liquid along the longitudinal axis of the barrel. The solution then leaves from the distal end at a ninety degree angle to the longitudinal barrel. The barrel can be inserted deep into an apparatus, such as the inside of an air conditioner unit, between the inner ‘grill’ surface and motor unit, where the cleaning solution spray from the distal end cleans along the air conditioner grill. The grill becomes free of residue and dirt on the inside as well as outside of the grill.

A second “A”-coil cleaning barrel is also removably attachable to the spraygun through standard male and female metal fittings. This is a flexible barrel having a rubber stopper at the distal end. The stopper sealingly fits onto hoses for pressure cleaning the inner surfaces of the hose. A rigid short spray stub barrel extends through the stopper. This barrel is maneuverable for cleaning inner surfaces that cannot be reached with an extended rigid traditional spraygun barrel, such as inside of a furnace. The hose barrel has a tapered spraycap, preferably made for seal-fitting onto an air conditioner drain hose, and remaining fixed thereon as a high pressure stream of fluid cleaning solution is sprayed into the hose. It is preferred that the sealing cap is a rubber stopper with a central aperture through which the cleaning solution and water flow. In this way, the air pressure and cleaning solution work to clean the hose line of residue.

While certain preferred embodiments of the present invention have been disclosed in detail, it is to be understood that various modifications may be adopted without departing from the spirit of the invention or scope of the following claims.

1. A multi-component feed system to feed at least two fluid material components through flexible hose to a spray gun, said system comprising:
a. a first major tank containing a first fluid component;
b. at least one second minor tank within said first tank, said second minor tank being removeable from said first tank, and containing a second fluid component, whereby the wall of the second tank serves as a partition wall to separate the fluid components of the two tanks, and the lid of the second tank has a greater diameter than an aperture through which the second tank is inserted into the first tank;
c. a pump means to pressurize the system to deliver the fluid components to the spray gun.

2. A feed system as claimed in claim 1, wherein said pump means is powered by a rechargeable battery.

3. A feed system as claimed in claim 1, and further including a removable spraygun barrel assembly adapted to spray in a direction substantially perpendicularly to the longitudinal axis of said barrel,

4. A feed system as claimed in claim 1, wherein said second tank is supported within said first tank by a lid on the second tank, said lid having a diameter that is greater than the diameter of an aperture in the wall of the first major tank through which the second tank is inserted.
